(19) United States
(12) Patent Application Publication
(10) Pub. No.: US 2012/0278181 A1
(43) Pub. Date: Nov. 1, 2012

(54) Advertising System and Method

(75) Inventors: Seokyoung Kim, Seoul (KR); Ki Oh Kwon, Seoul (KR); Gwangjin Yoo, Seoul (KR); Jhindhal Jhang, Jeju-si (KR)

(73) Assignee: DAUM COMMUNICATIONS CORP., Seoul (KR)

(21) Appl. No.: 13/456,160

(22) Filed: Apr. 25, 2012

(30) Foreign Application Priority Data
Apr. 28, 2011 (KR) 10-2011-0040145

(51) Int. Cl. G06Q 30/02

(52) U.S. Cl. 705/14.71

(57) ABSTRACT

An advertising system according to an exemplary embodiment of the present invention includes: an advertising selection unit that receives submission of an advertising bid including a reserved bid price and a desired ranking from each of the plurality of advertiser terminals and selects exposure candidate advertisements from the received bid submission advertisements; and a ranking determination unit that selects advertisements to be exposed, excluding the lowest ranking advertisement, from the exposure candidate advertisements, and determines an exposure ranking of the advertisements to be exposed.

### CROSS-REFERENCE TO RELATED APPLICATION

This application claims priority to and the benefit of Korean Patent Application No. 10-2011-0040145 filed in the Korean Intellectual Property Office on Apr. 28, 2011, the entire contents of which are incorporated herein by reference.

### BACKGROUND OF THE INVENTION

(a) Field of the Invention

The present invention relates to an advertising system and an advertising method.

(b) Description of the Related Art

An Internet user may search interested companies, or the like, on portal sites, or the like, and acquire information on the searched companies.

In this case, the user may perform a search by variously inputting keywords associated with the interested companies.

That is, when a user inputs keywords associated with companies, the portal sites, or the like, provide a search result list associated with the keywords input by the user to the user.

In connection with this, a search provider such as portal sites, or the like, uses keyword advertising to sell products, wherein the keyword advertising is an advertising method for exposing advertisement of relevant companies using the keywords input by the user.

Contract for the keyword advertising may be made between a search provider and an advertiser by various methods. An example thereof may include a bidding method.

The bidding method determines an exposure ranking according to various conditions, and bidding is performed in real time such that the exposure ranking may be consecutively changed.

However, the bidding method may deprive opportunities of an advertisement to be exposed when an advertiser fails in maintaining the ranking due to unscheduled bidding.

Therefore, an advertiser needs to continuously monitor the bidding so as to prevent deprivation of opportunities of advertising exposure and excessive competition between advertisers may be caused.

Therefore, advertising management costs of an advertiser may be increased.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an advertising system capable of allowing an advertiser to secure opportunities for advertising exposure at reasonable costs and to reasonably control advertising exposure in the advertiser desired ranking.

An exemplary embodiment of the present invention provides an advertising system, including: an advertising selection unit that receives submission of an advertising bid including a reserved bid price and a desired ranking from each of the plurality of advertiser terminals and selects exposure candidate advertisements from the received bid submission advertisements; and a ranking determination unit that selects advertisements to be exposed, excluding the lowest ranking advertisement, from the exposure candidate advertisements, and determines an exposure ranking of the advertisements to be exposed, wherein the reserved bid price is a static bid price or a maximum bid price, the ranking determination unit includes a reserved ranking determination unit that determines a reserved ranking of the advertisements to be exposed, and the reserved ranking determination unit arranges the advertisement having the lowest reserved bid price in the lowest ranking and determines the reserved ranking based on the desired ranking and the reserved bid price when the number of bid submission advertisements is equal to or more than the number of exposure candidate advertisements to be selected.

The reserved ranking determination unit may extract m ranking candidates as reserved, an advertisement of which the desired ranking is an m ranking or higher than the m ranking, and an advertisement having a static bid price as a reserved bid price, and determine an advertisement having the highest reserved bid price in the reserved m ranking candidate as a reserved m ranking advertisement.

The reserved ranking determination unit may determine the advertisement having the static bid price as the reserved bid price prior to the advertisement having a maximum bid price as the reserved bid price when the reserved bid price is the same in the reserved m ranking candidates.

The reserved ranking determination unit may determine the advertisement having a higher desired ranking as the reserved m ranking advertisement when the reserved bid price is the same and a type of the reserved bid prices is the same, in the reserved m ranking candidates.

The reserved ranking determination unit may determine the advertisement having a higher registration time ranking as the reserved m ranking advertisement when the reserved bid price is the same, a type of the reserved bid prices is the same, and the desired ranking is the same, in the reserved m ranking candidates.

The ranking determination unit may further include a bid price determination unit that determines a final bid price based on the reserved ranking and the reserved bid price.

The bid price determination unit may determine the final bid price of the lowest ranking advertisement as the reserved bid price of the lowest ranking advertisement, determine as the final bid price of a first advertisement having the static bid price as the reserved bid price the reserved bid price, and determine as the final bid price of a second advertisement having the max bid price as the reserved bid price a smaller price by comparing a reserved bid price of the second advertisement with an price obtained by adding a final bid price of a second ranking advertisement of the second advertisement to a minimum billing reference price.

The ranking determination unit may further include a final ranking determination unit that determines a final ranking based on the final bid price.

The final ranking determination unit may determine the final ranking in a high order of the final bid price.

The final ranking determination unit may determine the advertisement having the static bid price as the reserved bid price prior to the advertisement having the maximum bid price as the reserved bid price when the final bid price is the same.

The final ranking determination unit may determine the final ranking in a high order of the desired ranking when the final bid price is the same and the type of the reserved bid prices is the same.

The final ranking determination unit may determine the final ranking in a high order of the registration time ranking when the final bid price is the same, the type of the reserved bid prices is the same, and the desired ranking is the same.

The advertising system may further include a contract price determination unit that determines the contract bid price based on the reserved ranking or the final ranking and the final bid price.

The contract price determination unit may determine the contract price of the m ranking advertisement as a smaller price of a price obtained by adding the final bid price of an m+1 ranking advertisement to a minimum billing reference price and the final bid price of the m ranking advertisement.

The exposure candidate advertisements and the advertisements to be exposed may be the same when the number of bid submission advertisements is smaller than the number of exposure candidate advertisements to be selected, and the reserved ranking determination unit may determine the reserved ranking based on the desired ranking, the reserved bid price, and the registration time ranking of the advertisement bid when the number of bid submission advertisements is smaller than the number of exposure candidate advertisements to be selected.

When the number of bid submission advertisements is smaller than the number of exposure candidate advertisements to be selected, the bid price determination unit may determine as the final bid price of the lowest ranking advertisement an price smaller than the smallest reserved bid price among the reserved bid prices of the exposure candidate advertisements when the lowest ranking advertisement is an advertisement having the max bid price as the reserved bid price and determine as the final bid price the reserved bid price when the lowest ranking advertisement is an advertisement having the static bid price as the reserved bid price

When the number of bid submission advertisements is smaller than the number of exposure candidate advertisements to be selected, the contract price determination unit may determine, as the contract price of the lowest ranking advertisement, a smaller price than the smallest reserved bid price among the reserved bid prices of the exposure candidate advertisements.

Another exemplary embodiment of the present invention provides an advertising method, including: receiving submission of an advertising bid including a reserved bid price and a desired ranking from each of the plurality of advertiser terminals; selecting exposure candidate advertisements from the advertisement bid submission and selecting advertisement to be exposed, excluding a lowest ranking advertisement from the exposure candidate advertisements; and determining a reserved ranking of the advertisements to be exposed, wherein the reserved bid price is a static bid price or a maximum bid price, and the determining of the reserved ranking includes arranging the advertisement having the lowest reserved bid price in the lowest ranking, and determining the reserved ranking based on the desired ranking and the reserved bid price, when the number of bid submission advertisements is equal to or more than the number of exposure candidate advertisements to be selected.

The determining of the reserved ranking may further include extracting as reserved m ranking candidates an advertisement of which the desired ranking is an m ranking or higher than the m ranking and an advertisement having a static bid price as a reserved bid price; determining advertisement having the highest reserved bid price in the reserved m ranking candidates as a reserved m ranking advertisement; determining the advertisement having the static bid price as the reserved bid price prior to the advertisement having a max bid price as the reserved bid price when the reserved bid price is the same in the reserved m ranking candidates; determining the advertisement having the high desired ranking as the reserved m ranking advertisement when the reserved bid price is the same and a type of the reserved bid prices is the same, in the reserved m ranking candidates; and determining the advertisement having a higher registration time ranking as the reserved m ranking advertisement when the reserved bid price is the same, a type of the reserved bid prices is the same, the desired ranking is the same, in the reserved m ranking candidates.

The advertising method may further include determining a final ranking based on the reserved ranking and the final bid price.

The determining of the final ranking may include: determining the final bid price of the lowest ranking advertisement as the reserved bid price of the lowest ranking advertisement; determining the final bid price of a first advertisement having the static bid price as the reserved bid price as the reserved bid price; and determining, as the final bid price of a second advertisement having the maximum bid price as the reserved bid price, a smaller price by comparing a price obtained by adding a final biding price of a second ranking advertisement of the second advertisement to a minimum billing reference price with a reserved bid price of the second advertisement.

The advertising method may further include determining a final ranking based on the final bid price

The determining of the final ranking may include: determining the final ranking in a high order of the final bid price; determining the advertisement having the static bid price as the reserved bid price prior to the advertisement having the maximum bid price as the reserved bid price when the final bid price is the same; determining the final ranking in a high order of the desired ranking when the final bid price is the same and the type of the reserved bid prices is the same; and determining the final ranking in a high order of the registration time ranking when the final bid price is the same, the type of the reserved bid prices is the same, and the desired ranking is the same.

The advertising method may further include determining the contract price based on the reserved ranking or the final ranking and the final bid price, wherein the determining of the contract price may include determining the contract price of the m ranking advertisement as a smaller price of a price obtained by adding the final bid price of an m+1 ranking advertisement to a minimum billing reference price and the final bid price of the m ranking advertisement.

When the number of bid submission advertisements is smaller than the number of exposure candidate advertisements to be selected, the exposure candidate advertisements and the advertisements to be exposed are the same, the determining of the reserved ranking includes determining the reserved ranking based on the desired ranking, the reserved bid price, and the registration time ranking of the advertisement bid, and when the number of bid submission advertisements is smaller than the number of exposure candidate advertisements to be selected, the determining of the final bid price includes determining as the final bid price of the lowest ranking advertisement an price smaller than the smallest reserved bid price among the reserved bid prices of the exposure candidate advertisements when the lowest ranking advertisement is an advertisement having the max bid price as the reserved bid price and determining the reserved bid price as the final bid price when the lowest ranking advertisement is an advertisement having the static bid price as the reserved bid price, and the determining of the contract price includes determining as the contract price of the lowest ranking advertisement a smaller price than the smallest reserved bid price among the reserved bid prices of the exposure candidate advertisements when the number of bid submission advertisements is smaller than the number of exposure candidate advertisements to be selected.

According to the exemplary embodiment of the present invention, it is possible to allow the advertiser to secure opportunities for advertising exposure at reasonable costs and to reasonably control the advertising exposure in the advertiser desired ranking.

### BRIEF DESCRIPTION OF THE DRAWINGS

FIG. 1 is a block diagram showing an environment in which an advertising system according to an exemplary embodiment of the present invention is operated.

FIG. 2 is a block diagram of an advertising system according to the exemplary embodiment of the present invention.

FIG. 3 is a flowchart of an advertising method according to the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

An advertising system and an advertising method according to an exemplary embodiment of the present invention will be described with reference to the accompanying drawings.

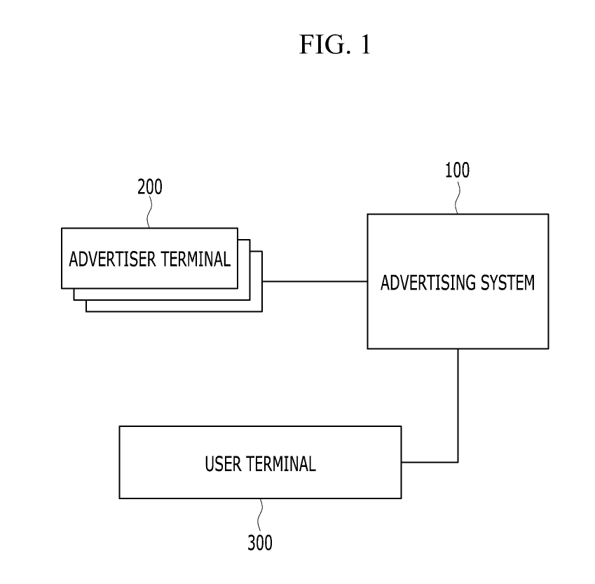

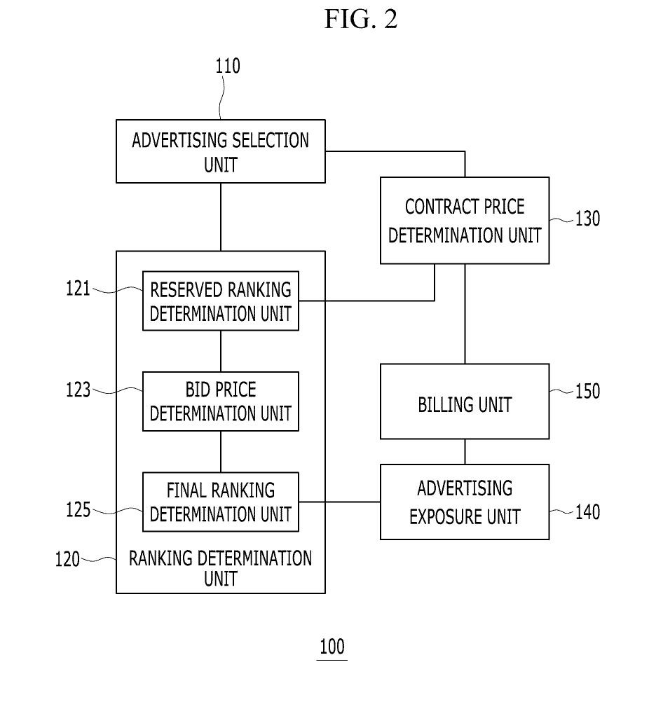

FIG. 1 is a block diagram showing an environment in which an advertising system according to an exemplary embodiment of the present invention is operated, and FIG. 2 is a block diagram of an advertising system according to the exemplary embodiment of the present invention.

Referring to FIG. 1, an advertising system 100 is a sever that registers a plurality of advertisements to be provided by each of a plurality of advertisers in response to a request of a plurality of advertiser terminals 200 used by each of the plurality of advertisers, and provides a search result list to a user terminal 300 according to an input keyword. In this case, the search result list provided to the user terminal 300 includes an advertisement of the advertiser terminal 200.

Here, the advertiser terminal 200 is a device that allows an advertiser to access the advertising system 100 through a network and communicate with the advertising system 100. As an example thereof, various communication devices such as a computer, a personal digital assistant (PDA), a mobile communication terminal, a television (TV), or the like, may be used.

In addition, the user terminal 300 is a device that allows a user to access the advertising system 100 through the network and communicate with the advertising system 100. Like the advertiser terminal 200, various communication devices such as a computer, a personal digital assistant, a mobile communication terminal, a television (TV), or the like, may be used.

Referring to FIG. 2, the advertising system 100 includes an advertising selection unit 110, a ranking determination unit 120, a contract price determination unit 130, an advertising exposure unit 140, and a billing unit 150.

The advertising selection unit 110 receives a submission of bids for advertising exposure of an advertiser from each of the plurality of advertiser terminals 200 and selects at least one advertisement to be actually exposed among a plurality of advertisements. The advertising selection unit 110 may receive information regarding the corresponding advertisement, a desired ranking, and a reserved bid price from the advertiser terminal 200.

In this case, the reserved bid price may be a static bid price (SBA) or a max bid price (MBA). The static bid price means that the bid price is fixed rather than being changed according to conditions and the max bid price means that the bid price is changed within a range of the max bid price according to conditions. The advertiser terminal 200 may select the static bid price or the max bid price in some cases. Meanwhile, when the reserved bid price is the static bid price, the advertiser terminal 200 does not define the desired ranking.

The advertising selection unit 110 selects at least n+1 exposure candidate advertisements among a plurality of advertisements when the number of advertisements to be exposed in the advertising system 100 is n, wherein the selection reference may be a high order of the reserved bid price of each advertisement.

The ranking determination unit 120 determines the exposure ranking of n advertisements excluding the lowest ranking advertisement from at least n+1 advertisement selected by the advertising selection unit 110, and includes a reserved ranking determination unit 121, a bid price determination unit 123, and a final ranking determination unit 125.

The reserved ranking determination unit 121 determines the reserved ranking of the rest n advertisements while the advertisement of the lowest price is fixed as the last ranking, that is, n+1 ranking when the advertising selection unit 110 selects n+1 advertisements. The reserved ranking determination unit 121 first extracts candidates of m ranking sequentially in a high order at the time of determining the advertisements of m ranking (m is an integer equal to or more than 1 and equal to or smaller than n). The reserved candidate of m ranking are an advertisement of which the desired ranking is m ranking or higher ranking than the m ranking and having a static bid price among advertisements of which the ranking is not determined beforehand by the advertiser terminal 200 of each advertisement. The reserved ranking determination unit 121 determines advertisements of the reserved m ranking from the candidates of the reserved m ranking. The determination reference is a high order of the reserved bid price. However, when the reserved bid prices are the same, advertisements having the static bid price rather than advertisements having the max bid price, advertisements having higher desired ranking, and advertisements having higher registration time ranking have priority in order. This will be described in more detail with reference to the following Table 1.

TABLE 1

| | Registration Time | | | |
|---|---|---|---|---|
| Ad | Ranking | Desired Ranking | SBA | MBA |
| E | 3 | 1 | | 400 |
| B | 6 | 1 | | 400 |
| F | 4 | 3 | | 400 |
| C | 1 | | 390 | |
| D | 2 | | 380 | |
| A | 5 | 1 | | 380 |

TABLE 2

| Ad | First Ranking | Second Ranking | Third Ranking | Fourth Ranking | Fifth Ranking |
|---|---|---|---|---|---|
| E | Candidate | | | | |
| | (Determination) | | | | |
| B | Candidate | Candidate | | | |
| | | (Determination) | | | |
| F | | | Candidate | | |
| | | | (Determination) | | |
| C | Candidate | Candidate | Candidate | Candidate | |
| | | | | (Determination) | |
| D | Candidate | Candidate | Candidate | Candidate | Candidate |
| | | | | | (Determination) |

Referring to Table 1, when the number of exposure advertisements is five, the advertising selection unit 110 receives a submission of bidding for the plurality of advertisements from the plurality of advertiser terminals 200, and selects six advertisements A, B, C, D, E, and F in a high order of the reserved bid price. Among those, the reserved bid price of advertisements C and D is the static bid price and the reserved bid price of advertisements A, B, E, and F is the maximum bid price. The reserved ranking determination unit 121 determines the advertisement A having the lowest reserved bid price as the lowest ranking, that is, the sixth ranking among six advertisements A, B, C, D, E, and F, and determines advertisements from the reserved first ranking to the reserved fifth ranking.

The reserved ranking determination unit 121 determines the advertisement of reserved first ranking. In detail, the advertisements B and E of which the desired ranking is the first ranking and the advertisements C and D of which the reserved bid price is the static bid price are extracted as candidates of the reserved first ranking and the advertisement E having the higher registration time ranking among the advertisements B and E having the highest reserved bid price of the candidates B, C, D, and E of the reserved first ranking is determined as the advertisement of the reserved first ranking.

Next, the reserved ranking determination unit 121 determines the advertisement of the reserved second ranking. In detail, among the advertisements of which the ranking is not determined, the advertisement B of which the desired ranking is the second ranking or higher than the second ranking and the advertisements C and D of which the reserved bid price is the static bid price are extracted as candidates of the reserved second ranking, and the advertisement B having the highest reserved bid price of the candidates B, C, and D of the reserved second ranking is determined as the advertisement of the reserved second ranking.

Subsequently, the reserved ranking determination unit 121 determines the advertisement of the reserved third ranking. In detail, among the advertisements of which the ranking is not determined, the advertisement F of which the desired ranking is the third ranking or higher than the third ranking and the advertisements C and D of which the reserved bid price is the static bid price are extracted as candidates of the reserved third ranking, and the advertisement F having the highest reserved bid price of the candidates C, D, and F of the reserved third ranking is determined as the advertisement of the reserved third ranking.

Subsequently, the reserved ranking determination unit 121 determines the advertisement of the reserved fourth ranking. In detail, among the advertisements of which the ranking is not determined, the advertisement (no object) of which the desired ranking is the fourth ranking or higher than the fourth ranking and the advertisements C and D of which the reserved bid price is the static bid price are extracted as candidates of the reserved fourth ranking, and the advertisement C having the highest reserved bid price of the candidates C and D of the reserved fourth ranking is determined as the advertisement of the reserved fourth ranking.

Next, the reserved ranking determination unit 121 determines the remaining advertisement D as the advertisement of the reserved fifth ranking.

Hereinafter, another exemplary embodiment of the present invention will be described with reference to Table 3 and Table 4.

TABLE 3

| | Registration Time | | | |
|---|---|---|---|---|
| Ad | Ranking | Desired Ranking | SBA | MBA |
| B | 5 | 4 | | 520 |
| A | 1 | | 500 | |
| C | 2 | 2 | | 300 |
| D | 3 | 2 | | 280 |
| E | 4 | 2 | | 270 |
| F | 6 | | 210 | |

TABLE 4

| Ad | First Ranking | Second Ranking | Third Ranking | Fourth Ranking | Fifth Ranking |
|---|---|---|---|---|---|
| B | | | | Candidate | |
| | | | | (Determination) | |
| A | Candidate | | | | |
| | (Determination) | | | | |
| C | | Candidate | | | |
| | | (Determination) | | | |
| D | | Candidate | Candidate | | |
| | | | (Determination) | | |
| E | | Candidate | Candidate | Candidate | Candidate |
| | | | | | (Determination) |

Referring to Table 3, when the number of exposure advertisements is five, the advertising selection unit 110 receives a submission of bidding for the plurality of advertisements from the plurality of advertiser terminals 200 and selects 6 advertisements A, B, C, D, E, and F in a high order of the reserved bid price. Among those, the reserved bid price of advertisements A and F is the static bid price and the reserved bid price of advertisements B, C, D, and E is the maximum bid price. The reserved ranking determination unit 121 determines the advertisement F having the lowest reserved bid price as the lowest ranking, that is, the sixth ranking among six advertisements A, B, C, D, E, and F, and determines advertisements from the reserved first ranking to the reserved fifth ranking.

The reserved ranking determination unit 121 determines the advertisement of the reserved first ranking. In detail, the advertisement(no object) of which the desired ranking is the first ranking and the advertisement A of which the reserved bid price is the static bid price are extracted as candidates of the reserved first candidate and a single candidate A of a reserved first ranking is determined as an advertisement of reserved first ranking.

Next, the reserved ranking determination unit 121 determines the advertisement of the reserved second ranking. In detail, among the advertisements of which the ranking is not determined, the advertisements C, D, and E of which the desired ranking is the second ranking or higher than the second ranking and the advertisement (no object) of which the reserved bid price is the static bid price are extracted as candidates of the reserved second ranking, and the advertisement C having the highest reserved bid price of the candidates C, D, and E of the reserved second ranking is determined as the advertisement of the reserved second ranking.

Subsequently, the reserved ranking determination unit 121 determines the advertisement of the reserved third ranking. In detail, among the advertisements of which the ranking is not determined, the advertisements D and E of which the desired ranking is the third ranking or higher than the third ranking and the advertisement (no object) of which the reserved bid price is the static bid price are extracted as candidates of the reserved third ranking, and the advertisement D having the highest reserved bid price of the candidates D and E of the reserved third ranking is determined as the advertisement of the reserved third ranking.

Subsequently, the reserved ranking determination unit 121 determines the advertisement of the reserved fourth ranking. In detail, among the advertisements of which the ranking is not determined, the advertisements B and E of which the desired ranking is the fourth ranking or higher than the fourth ranking and the advertisement (no object) of which the reserved bid price is the static bid price are extracted as candidates of the reserved fourth ranking, and the advertisement B having the highest reserved bid price of the candidates B and E of the reserved fourth ranking is determined as the advertisement of the reserved fourth ranking.

Next, the reserved ranking determination unit 121 determines the remaining advertisement E as the advertisement of the reserved fifth ranking.

Hereinafter, another exemplary embodiment of the present invention will be described with reference to Table 5 and Table 6.

TABLE 5

| | Registration Time | | | |
|---|---|---|---|---|
| Ad | Ranking | Desired Ranking | SBA | MBA |
| F | 4 | 3 | | 700 |
| D | 1 | 3 | | 680 |
| C | 6 | 3 | | 620 |
| B | 5 | 3 | | 600 |
| E | 3 | 3 | | 580 |
| A | 2 | 3 | 550 | |

TABLE 6

| | First | Second | | | | | |
|---|---|---|---|---|---|---|---|
| Ad | Ranking | Ranking | Third Ranking | Fourth Ranking | Fifth Ranking | Sixth Ranking | Seventh Ranking |
| F | | | Candidate | | | | |
| | | | (Determination) | | | | |
| D | | | Candidate | Candidate | | | |
| | | | | (Determination) | | | |
| C | | | Candidate | Candidate | Candidate | | |
| | | | | | (Determination) | | |
| B | | | Candidate | Candidate | Candidate | Candidate | |
| | | | | | | (Determination) | |
| E | | | Candidate | Candidate | Candidate | Candidate | Candidate |
| | | | | | | | (Determination) |

Referring to Table 5, when the number of exposure advertisements is five, the advertising selection unit 110 receives a submission of bidding for the plurality of advertisements from the plurality of advertiser terminals 200, and selects six advertisements A, B, C, D, E, and F in a high order of the reserved bid price. Among those, the reserved bid price of advertisement A is the static bid price and the reserved bid price of advertisements B, C, D, E, and F is the maximum bid price. The reserved ranking determination unit 121 determines advertisement A having the lowest reserved bid price as the lowest ranking, that is, the sixth ranking among sixth advertisements A, B, C, D, E, and F, and determines advertisements from the reserved first ranking to the reserved fifth ranking.

The reserved ranking determination unit 121 determines the advertisement of the reserved first ranking. In detail, the advertisement (no object) of which the desired ranking is the first ranking and the advertisement (no object) of which the reserved bid price is the static bid price are extracted as a candidate of the reserved first ranking, but according to the exemplary embodiment of the present invention, there is no candidate of the reserved first ranking and therefore the ranking passes to the next ranking.

The reserved ranking determination unit 121 extracts the advertisement (no object) of which the desired ranking is the second ranking or higher than the second ranking and the advertisement (no object) of which the reserved bid price is the static bid price as the candidate of the reserved second ranking, among the advertisements of which the ranking is not determined, but there is no candidate of the reserved second ranking, so the ranking passes to next ranking.

The reserved ranking determination unit 121 extracts the advertisements B, C, D, E, and F of which the desired ranking is the third ranking or higher than the third ranking and the advertisement (no object) of which the reserved bid price is the static bid price as candidates of the reserved third ranking, among the advertisements of which the ranking is not determined, and determines the advertisement F having the highest reserved bid price of the candidates B, C, D, E, and F of the reserved third ranking as the advertisement of the reserved third ranking.

Subsequently, the reserved ranking determination unit 121 determines the advertisement of the reserved fourth ranking. In detail, among the advertisements of which the ranking is not determined, the advertisements B, C, D, and E of which the desired ranking is the fourth ranking or higher than the fourth ranking and the advertisement (no object) of which the reserved bid price is the static bid price are extracted as candidates of the reserved fourth ranking, and the advertisement D having the highest reserved bid price of the candidates B, C, D, and E of the reserved fourth ranking is determined as the advertisement of the reserved fourth ranking.

Next, the reserved ranking determination unit 121 determines the advertisement of the reserved fifth ranking. In detail, among the advertisements of which the ranking is not determined, the advertisements B, C, and E of which the desired ranking is the fifth ranking or higher than the fifth ranking and the advertisement (no object) of which the reserved bid price is the static bid price are extracted as candidates of the reserved fifth ranking, and the advertisement C having the highest reserved bid price of the candidates B, C, and E of the reserved fifth ranking is determined as the advertisement of the reserved fifth ranking.

Next, the reserved ranking determination unit 121 determines the advertisement of the reserved sixth ranking. In detail, among the advertisements of which the ranking is not determined, the advertisements B and E of which the desired ranking is the sixth ranking or higher than the sixth ranking and the advertisement (no object) of which the reserved bid price is the static bid price are extracted as candidates of the reserved fifth ranking, and the advertisement B having the highest reserved bid price of the candidates B and E of the reserved fifth ranking is determined as the advertisement of the reserved sixth ranking.

Next, the reserved ranking determination unit 121 determines the remaining advertisement E as the advertisement of the reserved seventh ranking.

According to the exemplary embodiment of the present invention, there is no reserved first ranking or reserved second ranking and therefore the reserved third ranking to the reserved seventh ranking are sequentially determined as the reserved first ranking to the reserved fifth ranking.

Referring again to FIG. 2, the bid price determination unit 123 determines the final bid prices of each advertisement A to F based on the reserved ranking determined in the reserved ranking determination unit 121.

Describing in detail, the final bid price of the advertisement determined as the reserved lowest ranking becomes the reserved bid price. The other reserved rankings are as follows.

When the reserved bid price is the static bid price, the reserved bid price becomes the final bid price. When the reserved bid price of the reserved m ranking advertisement is the max bid price, a smaller price of the max bid price and a sum of the final bid price of the reserved m+1 ranking to a minimum billing reference price is determined as the final bid price of the reserved m ranking advertisement. In this case, the minimum billing reference price may be, for example, 10. Further, the final bid price of the advertisement determined as the reserved lowest ranking is determined as the reserved bid price. This will be described in detail with reference to Table 7 to Table 9.

TABLE 7

| | Registration | Desired | | | |
|---|---|---|---|---|---|
| Ad | Time Ranking | Ranking | SBA | MBA | Final Bid Price |
| E | 3 | 1 | | 400 | 400 |
| B | 6 | 1 | | 400 | 400 |
| F | 4 | 3 | | 400 | 400 |
| C | 1 | | 390 | | 390 |
| D | 2 | | 380 | | 380 |
| A | 5 | 1 | | 380 | 380 |

Referring to FIG. 7, the final bid price of the advertisement A that is the reserved lowest ranking is 380 that is the reserved bid price. Since each reserved bid price of the advertisements C and D that are the reserved fourth ranking and the reserved fifth ranking is the static bid price, the final bid price is equal to the reserved bid price.

The final bid price of the advertisement F that is the reserved third ranking is determined as a smaller one of 400 obtained by adding 390 that is the final bid price of the advertisement C that is the reserved fourth ranking to 10, and 400 that is the reserved bid price of the advertisement F. In this case, the two prices are equal to each other and therefore the final bid price becomes 400.

The final bid price of the advertisement B that is the reserved second ranking becomes 400 that is a smaller price of 410 obtained by adding 400 that is the final bid price of the advertisement F that is the reserved third ranking to 10 and 400 that is the reserved bid price of the advertisement B.

The final bid price of the advertisement E that is the reserved first ranking becomes 400 that is a smaller price of 410 obtained by adding 400 that is the final bid price of the advertisement E that is the reserved second ranking to 10 and 400 that is the reserved bid price of the advertisement E.

TABLE 8

| | Registration | Desired | | | |
|---|---|---|---|---|---|
| Ad | Time Ranking | Ranking | SBA | MBA | Final Bid Price |
| A | 1 | | 500 | | 500 |
| C | 2 | 2 | | 300 | 250 |
| D | 3 | 2 | | 280 | 240 |
| B | 5 | 4 | | 520 | 230 |
| E | 4 | 2 | | 270 | 220 |
| F | 6 | | 210 | | 210 |

Referring to FIG. 8, the final bid price of the advertisement F that is the reserved lowest ranking is 210 that is the reserved bid price.

The final bid price of the advertisement E that is the reserved fifth ranking becomes 220 that is a smaller price of 220 obtained by adding 210 that is the final bid price of the advertisement F that is the reserved sixth ranking to 10 and 270 that is the reserved bid price of the advertisement E.

The final bid price of the advertisement B that is the reserved fourth ranking becomes 230 that is a smaller price of 230 obtained by adding 220 that is the final bid price of the advertisement E that is the reserved fifth ranking to 10 and 520 that is the reserved bid price of the advertisement B.

The final bid price of the advertisement D that is the reserved third ranking becomes 240 that is a smaller price of 240 obtained by adding 230 that is the final bid price of the advertisement B that is the reserved fourth ranking to 10 and 280 that is the reserved bid price of the advertisement D.

The final bid price of the advertisement C that is the reserved second ranking becomes 250 that is a smaller price of 250 obtaining by adding 240 that is the final bid price of the advertisement D that is the reserved third ranking to 10 and 300 that is the reserved bid price of the advertisement C.

Since reserved bid price of the advertisement A that is the reserved first ranking is the static bid price, the final bid price is equal to the static bid price.

TABLE 9

| | Registration | Desired | | | |
|---|---|---|---|---|---|
| Ad | Time Ranking | Ranking | SBA | MBA | Final Bid Price |
| F | 4 | 3 | | 700 | 600 |
| D | 1 | 3 | | 680 | 590 |
| C | 6 | 3 | | 620 | 580 |
| B | 5 | 3 | | 600 | 570 |
| E | 3 | 3 | | 580 | 560 |
| A | 2 | | 550 | | 550 |

Referring to FIG. 9, the final bid price of the advertisement A that is the reserved lowest ranking is 550 that is the reserved bid price.

The final bid price of the advertisement E that is the reserved fifth ranking becomes 560 that is a smaller price of 560 obtained by adding 550 that is the final bid price of the advertisement A that is the reserved sixth ranking to 10 and 580 that is the reserved bid price of the advertisement E.

The final bid price of the advertisement B that is the reserved fourth ranking becomes 570 that is a smaller price of 570 obtained by adding 560 that is the final bid price of the advertisement E that is the reserved fifth ranking to 10 and 600 that is the reserved bid price of the advertisement B.

The final bid price of the advertisement C that is the reserved third ranking becomes 580 that is a smaller price of 580 obtained by adding 570 that is the final bid price of the advertisement B that is the reserved fourth ranking to 10 and 620 that is the reserved bid price of the advertisement C.

The final bid price of the advertisement D that is the reserved second ranking becomes 590 that is a smaller price of 590 obtained by adding 580 that is the final bid price of the advertisement C that is the reserved third ranking to 10 and 680 that is the reserved bid price of the advertisement D.

The final bid price of the advertisement F that is the reserved first ranking becomes 600 that is a smaller price of 600 obtained by adding 590 that is the final bid price of the advertisement D that is the reserved second ranking to 10 and 700 that is the reserved bid price of the advertisement F.

Referring again to FIG. 2, the final ranking determination unit 125 determines the final exposure ranking of the advertisements A to F based on the final bid price that is determined by the bid price determination unit 123. The detailed method is as follows.

The final ranking determination unit 125 aligns the advertisements A to F in order of the final bid price determined by the bid price determination unit 123 and the advertisement of which the reserved bid price is the static bid price, the advertisement having the high desired ranking, and the advertisement having the rapid registration time have priority in sequence, when the advertisements has the same final bid price. This will be described in more detail with reference to the following Table 10.

TABLE 10

| | Desired | | | Reserved | | |
|---|---|---|---|---|---|---|
| Ad | Ranking | SBA | MBA | Ranking | Final Bid Price | Final Ranking |
| B | 2 | | 130 | 2 | 130 | 1 |
| A | | 120 | | 1 | 120 | 2 |
| C | 3 | | 140 | 3 | 120 | 3 |
| D | | 110 | | 4 | 110 | 4 |
| E | | 100 | | 5 | 100 | 5 |
| F | 1 | | 90 | 6 | 90 | 6 |

The reserved ranking determination unit 121 determines the reserved ranking of the advertisements A to F like Table 10 according to the aforementioned contents, and the bid price determination unit 123 determines the final bid price of the advertisements A to F like Table 10. The final ranking determination unit 125 arranges the advertisements A to F in a high order of the final bid price and determines the final ranking like Table 10 by allowing the advertisement A of which the reserved bid price is the static bid price to have higher priority than the advertisement C of which the reserved bid price is the maximum bid price, when the advertisements A and C have the same final bid price.

Referring again to FIG. 2, the contract price determination unit 130 determines the contract prices of each advertisement A to F according to the final bid price determined by the bid price determination unit 123 and the final ranking determined by the final ranking determination unit 125. In detail, the contract price determination unit 130 determines a smaller price of a price obtained by adding the minimum billing reference price to the final bid price of m+1 ranking and the maximum bid price of an m ranking advertisement as the contract price of an m ranking advertisement. In this case, the minimum billing reference price may be, for example, 10. This will be described in more detail with reference to the following Table 11.

TABLE 11

| | Desired | | | Final Bid | | |
|---|---|---|---|---|---|---|
| Ad | Ranking | SBA | MBA | Price | Final Ranking | Contract Price |
| B | 2 | | 130 | 130 | 1 | 130 |
| A | | 120 | | 120 | 2 | 120 |
| C | 3 | | 140 | 120 | 3 | 120 |
| D | | 110 | | 110 | 4 | 110 |
| E | | 100 | | 100 | 5 | 100 |
| F | 1 | | 90 | 90 | 6 | |

Referring to Table 11, the contract price of the fifth ranking advertisement E is determined as the smaller value by comparing 100 that is a value obtained by adding 90 that is the final bid price of the sixth ranking advertisement F to 10 with 100 that is its own final bid price. In this case, the two values are equal to each other and therefore the contract price of the advertisement E becomes 100.

The contract price of the fourth ranking advertisement D is determined as the smaller value by comparing 110 obtained by adding 100 that is the final bid price of the fifth ranking advertisement F to 10 with 110 that is its own final bid price. In this case, the two values are equal to each other and therefore the contract price of the advertisement D becomes 110.

The contract price of the third ranking advertisement C is determined as the smaller value by comparing 120 obtained by adding 110 that is the final bid price of the fourth ranking advertisement D to 10 with 120 that is its own final bid price. In this case, the two values are equal to each other and therefore the contract price of the advertisement C becomes 120.

The contract price of the second ranking advertisement A is determined as the smaller value by comparing 130 obtained by adding 120 that is the final bid price of the third ranking advertisement C to 10 with 120 that is its own final bid price. In this case, the smaller value is 120 and therefore the contract price of the advertisement A becomes 120.

The contract price of the first ranking advertisement B is determined as the smaller value by comparing 130 obtained by adding 120 that is the final bid price of the second ranking advertisement A to 10 with 130 that is its own final bid price. In this case, the two values are equal to each other and therefore the contract price of the advertisement B becomes 130.

Meanwhile, the contents described above relate to the case in which the advertisements are selected corresponding to the number of advertisements necessary to determine the exposure ranking and the billing, that is, one more (n+1) than the number n of exposure candidate advertisements, since the advertisement to be selected is sufficient. Hereinafter, the case in which the advertisements may not be selected corresponding to the required number since the number of advertisements to be selected is insufficient will be described. This case corresponds to the case in which the advertiser terminals 200 that are smaller in numbers than expected submit a bid.

The advertising selection unit 110 selects an advertisement in high order based on the reserved bid price.

Unlike the aforementioned exemplary embodiment, the reserved ranking determination unit 121 determines the reserved ranking as described above without fixing the lowest ranking.

The bid price determination unit 123 determines the final bid prices of each advertisement by the above-mentioned method. However, unlike the above-mentioned description, when the reserved bid price of the advertisement last arranged in the reserved ranking determined by the reserved ranking determination unit 121 is the maximum bid price, the bid price determination unit 123 may fix the final bid price to a constant price. In this case, the constant price may be set to be a smaller price than the reserved bid prices of all the advertisements, for example, 70. When the reserved bid price of the advertisement last arranged in the reserved ranking determined by the reserved ranking determination unit 121 to be the static bid price, the reserved bid price is determined as the final bid price.

The final ranking determination unit 125 determines the final rankings of each advertisement like the above-mentioned method.

The contract bid determination unit 130 determines the contract prices of each advertisement by the above-mentioned method, but the contract price of the advertisement of the last ranking may be set to be a smaller price than the reserved bid prices of all the advertisements, for example, 70.

This will be described in detail with reference to Table 12.

TABLE 12

| | Regis- | | | | | | | |
|---|---|---|---|---|---|---|---|---|
| | tration | | | | | Final | | Con- |
| | Time | Desired | | | Reserved | Bid | Final | tract |
| Ad | Ranking | Ranking | BA | MBA | Ranking | Price | Ranking | Price |
| B | 5 | 4 | | 520 | 4 | 70 | 3 | 70 |
| A | 1 | | 500 | | 1 | 500 | 1 | 90 |
| C | 2 | 2 | | 300 | 2 | 80 | 2 | 80 |

Referring to Table 12, when the advertisements A, B, and C are arranged in a high order of the reserved bid price, B>A>C, and the reserved ranking determination unit 121 determines the reserved ranking of the advertisements A to C. In detail, the reserved first ranking candidate is the advertisement A and has a single candidate and therefore the advertisement A becomes the reserved first ranking. The reserved second ranking candidate is the advertisement C and has a single candidate and therefore the advertisement C becomes the reserved second ranking, the reserved third ranking candidate has no object, and the reserved fourth ranking candidate is the advertisement B and has a single candidate and therefore the remaining advertisement B is the reserved fourth ranking.

The bid price determination unit 123 determines the final bid price of the advertisements A to C. In detail, since the reserved bid price of the advertisement B of the reserved fourth ranking that is the lowest ranking is the maximum bid price, the final bid price is set to be 70. Further, there is no reserved third ranking advertisement and the final bid price of the reserved second advertisement C becomes 80 that is a smaller value of 80 obtained by adding 70 that is the final bid price of the reserved fourth ranking advertisement B to 10 and 300 that is the reserved bid price of the advertisement C. Since the reserved bid price of the reserved first ranking advertisement A is the static bid price, the reserved bid price becomes the final bid price.

The final ranking determination unit 125 determines the final exposure ranking of the advertisements A to C. However, according to the exemplary embodiment of the present invention, the final bid prices of all of the advertisements A to C are different and therefore, describing the final ranking, the advertisement A becomes the first ranking, the advertisement C becomes the second ranking, and the advertisement B becomes the third ranking.

The contract price determination unit 130 determines the contract price of the advertisements A to C. In detail, the reserved bid price of the advertisement B that is the last ranking is the max bid price and therefore, the contract price thereof is 70. The contract price of the second ranking advertisement C is determined by comparing 80 obtained by adding 70 that is the final bid price of the third ranking advertisement B to 10 with 80 that is the final bid price of the advertisement C. In this case, two values are equal to each other, and therefore, the contract price thereof is determined as 80. The contract price of the first ranking advertisement A is determined as 90 that is a smaller price when comparing 90 obtained by adding 80 that is the final bid price of the second ranking advertisement C to 10 with 500 that is its own final bid price.

Referring again to FIG. 2, the advertising exposure unit 140 exposes the advertisement according to the exposure ranking determined by the final ranking determination unit 125. That is, when the user terminal 300 inputs specific keywords, the plurality of advertisements are provided as a result list according to the exposure ranking.

The billing unit 150 charges the advertiser terminal 200 based on the contract prices of each advertisement determined by the contract price determination unit 130, the search result inquiry activity of the user terminal 300, or the like. For example, when the contract price of the specific advertisement is 200 and a frequency of clicking the specific advertisement by the user terminal 300 is 1000 times, the result obtained by multiplying 200 by 1000 may be the billing for the adviser terminal 200.

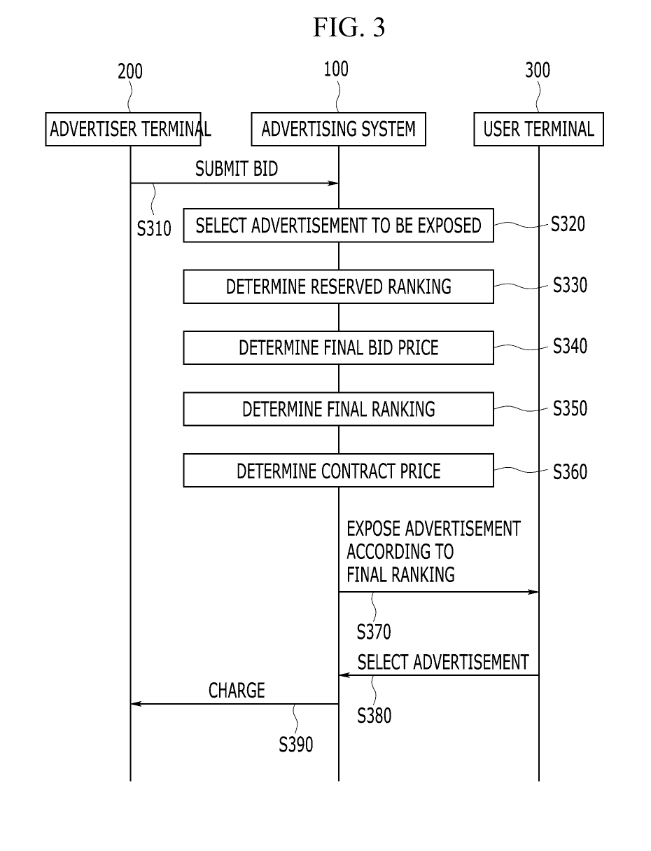

An advertising method according to another exemplary embodiment of the present invention will be described below with reference to FIG. 3.

FIG. 3 is a flowchart showing an advertising method according to another exemplary embodiment of the present invention.

Referring to FIG. 3, the advertiser terminal 200 submits a bid to the advertising system 100 (S310). In this case, the advertiser terminal 200 transmits the reserved bid price that is the static bid price or the maximum bid price and the desired ranking for the exposure to the advertising system 100.

The advertising system 100 receives the bid submission from the advertiser terminal 200, and then selects the advertisement to be exposed according to the number of exposure advertisements (S320). In this case, the selection reference may be a high order of the reserved bid price of the advertisement.

Next, the advertising system 100 determines the reserved ranking of the selected advertisement (S330). A method of determining the reserved exposure ranking divides the case in which the number of selected advertisements is smaller than the number of exposure advertisements and the case in which the number of selected advertisements is the same as the number of exposure advertisements and is performed based on the reserved bid price, the desired ranking, the registration time ranking, or the like. The detailed description thereof is the same as the operation of the above-mentioned reserved ranking determination unit 121, and therefore will be omitted.

The advertisement system 100 determines the final bid price of the advertisement based on the reserved ranking and the reserved bid price (S340). The detailed description thereof is the same as the operation of the above-mentioned bid price determination unit 123, and therefore will be omitted.

The advertising system 100 determines the final ranking of the advertisement based on the reserved ranking, the final bid price, the types of reserved bid prices, the desired ranking, and the registration time (S350). The detailed description thereof is the same as the operation of the above-mentioned final ranking determination unit 125, and therefore will be omitted.

Next, the advertising system 100 determines the contract price of the advertisement according to the reserved ranking or the final ranking and the final bid price (360). The detailed description thereof is the same as the operation of the above-mentioned contract price determination unit 130, and therefore will be omitted.

The advertising system 100 exposes the advertisement to the user terminal 300 according to the determined final ranking (S370). Generally, the user terminal 300 transmits the specific keyword to the advertising system 100 and the advertising system 100 provides the advertisement as the search result according to the specific keyword to the user terminal 300. Therefore, the user terminal 300 may select the advertisement provided by the advertisement system 100 and may transmit the selection information to the advertisement system 100 (S380).

Further, the advertising system 100 determines the billing according to the contract price of each advertisement and the activity of the user terminal 300 selecting the corresponding advertisement, and charges the advertiser terminal 200 (S390).

The above-mentioned exemplary embodiments of the present invention are not embodied only by an apparatus and method. Alternatively, the above-mentioned exemplary embodiments may be embodied by a program performing functions which correspond to the configuration of the exemplary embodiments of the present invention, or a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An advertising system, comprising:
an advertising selection unit that receives submission of an advertising bid comprising a reserved bid price and a desired ranking from each of the plurality of advertiser terminals and selects exposure candidate advertisements from the received bid submission advertisements; and a ranking determination unit that selects advertisements to be exposed, excluding the lowest ranking advertisement, from the exposure candidate advertisements, and determines an exposure ranking of the advertisements to be exposed,
wherein the reserved bid price is a static bid price or a maximum bid price,
the ranking determination unit comprises a reserved ranking determination unit that determines a reserved ranking of the advertisements to be exposed, and
the reserved ranking determination unit arranges the advertisement having the lowest reserved bid price in the lowest ranking, and determines the reserved ranking based on the desired ranking and the reserved bid price when the number of bid submission advertisements is equal to or more than the number of exposure candidate advertisements to be selected.

2. The advertising system of claim 1, wherein the reserved ranking determination unit extracts m ranking candidates as reserved, an advertisement of which the desired ranking is an m ranking or higher than the m ranking, and an advertisement having the static bid price as the reserved bid price, and determines an advertisement having the highest reserved bid price of the reserved m ranking candidates as a reserved m ranking advertisement.

3. The advertising system of claim 2, wherein the reserved ranking determination unit determines the advertisement having the static bid price as the reserved bid price earlier than the advertisement having a maximum bid price as the reserved bid price, when the reserved bid price is the same in the reserved m ranking candidates.

4. The advertising system of claim 3, wherein the reserved ranking determination unit determines the advertisement having the high desired ranking as the reserved m ranking advertisement, when the reserved bid price is the same and a type of the reserved bid prices is the same, in the reserved m ranking candidates.

5. The advertising system of claim 4, wherein the reserved ranking determination unit determines the advertisement having a high registration time ranking as the reserved m ranking advertisement, when the reserved bid price is the same, a type of the reserved bid price is the same, and the desired ranking is the same, in the reserved m ranking candidates.

6. The advertising system of claim 1, wherein the ranking determination unit further comprises a bid price determination unit that determines a final bid price based on the reserved ranking and the reserved bid price.

7. The advertising system of claim 6, wherein the bid price determination unit
determines the final bid price of the lowest ranking advertisement as the reserved bid price of the lowest ranking advertisement,
determines the reserved bid price as the final bid price regarding a first advertisement having the static bid price as the reserved bid price, and
determines a smaller price as the final bid price of a second advertisement having the maximum bid price as the reserved bid price by comparing a price obtained by adding a final bid price of a second ranking advertisement of the second advertisement to a minimum billing reference price with a reserved bid price of the second advertisement.

8. The advertising system of claim 6, wherein the ranking determination unit further comprises a final ranking determination unit that determines a final ranking based on the final bid price.

9. The advertising system of claim 8, wherein the final ranking determination unit determines the final ranking in a high order of the final bid price.

10. The advertising system of claim 9, wherein the final ranking determination unit determines the advertisement having the static bid price as the reserved bid price earlier than the advertisement having the maximum bid price as the reserved bid price when the final bid price is the same.

11. The advertising system of claim 10, wherein the final ranking determination unit determines the final ranking in a high order of the desired ranking, when the final bid price is the same and the type of the reserved bid prices is the same.

12. The advertising system of claim 11, wherein the final ranking determination unit determines the final ranking in a high order of the registration time ranking when the final bid price is the same, the type of the reserved bid prices is the same, and the desired ranking is the same.

13. The advertising system of claim 6, further comprising a contract price determination unit that determines a contract price based on the reserved ranking or the final ranking and the final bid price.

14. The advertising system of claim 13, wherein the contract price determination unit determines the contract price of the m ranking advertisement as a smaller price of a price obtained by adding the final bid price of an m+1 ranking advertisement to a minimum billing reference price and the final bid price of the m ranking advertisement.

15. The advertising system of claim 13, wherein when the number of bid submission advertisements is smaller than the number of exposure candidate advertisements to be selected,
the exposure candidate advertisements and the advertisements to be exposed are the same, and
the reserved ranking determination unit determines the reserved ranking based on the desired ranking, the reserved bid price, and the registration time ranking of the advertisement bid when the number of bid submission advertisements is smaller than the number of exposure candidate advertisements to be selected.

16. The advertising system of claim 15, wherein the bid price determination unit, when the number of bid submission advertisements is smaller than the number of exposure candidate advertisements to be selected, regarding the final bid price of the lowest ranking advertisement, determines a smaller price than the smallest reserved bid price among the reserved bid prices of the exposure candidate advertisements as the final bid price when the lowest ranking advertisement is an advertisement having the maximum bid price as the reserved bid price, and determines the reserved bid price as the final bid price when the lowest ranking advertisement is an advertisement having the static bid price as the reserved bid price.

17. The advertising system of claim 16, wherein the contract price determination unit, when the number of bid submission advertisements is smaller than the number of exposure candidate advertisements to be selected, regarding the contract price of the lowest ranking advertisement, determines a smaller price than the smallest reserved bid price among the reserved bid prices of the exposure candidate advertisements as the contract price.

18. An advertising method, comprising:
receiving submission of an advertising bid comprising a reserved bid price and a desired ranking from each of the plurality of advertiser terminals;
selecting exposure candidate advertisements from the advertisement bid submission and selecting an advertisement to be exposed, excluding a lowest ranking advertisement from the exposure candidate advertisements; and
determining a reserved ranking of the advertisements to be exposed,
wherein the reserved bid price is a static bid price or a maximum bid price, and
the determining of the reserved ranking comprises, when the number of bid submission advertisements is equal to or more than the number of exposure candidate advertisements to be selected, arranging the advertisement having the lowest reserved bid price in the lowest ranking, and determining the reserved ranking based on the desired ranking and the reserved bid price.

19. The advertising method of claim 18, wherein
the determining of the reserved ranking further comprises:
extracting m ranking candidates as reserved, an advertisement of which the desired ranking is an m ranking or higher than the m ranking, and an advertisement having a static bid price as a reserved bid price;
determining an advertisement having the highest reserved bid price of the reserved m ranking candidates as a reserved m ranking advertisement;
determining the advertisement having the static bid price as the reserved bid price earlier than the advertisement having a maximum bid price as the reserved bid price when the reserved bid price is the same in the reserved m ranking candidates;
determining the advertisement having the high desired ranking as the reserved m ranking advertisement when the reserved bid price is the same and a type of the reserved bid prices is the same, in the reserved m ranking candidates; and
determining the advertisement having a high registration time ranking as the reserved m ranking advertisement when the reserved bid price is the same, a type of the reserved bid prices is the same, and the desired ranking is the same, in the reserved m ranking candidates.

20. The advertising method of claim 18, further comprising determining a final bid price based on the reserved ranking and the reserved bid price.

21. The advertising method of claim 20, wherein the determining of the final bid price comprises:
determining the final bid price of the lowest ranking advertisement as the reserved bid price of the lowest ranking advertisement;
determining as the final bid price of a first advertisement having the static bid price as the reserved bid price the reserved bid price; and
determining, as the final bid price of a second advertisement having the maximum bid price as the reserved bid price, a smaller price by comparing a price obtained by adding a final bid price of a second ranking advertisement of the second advertisement to a minimum billing reference price with a reserved bid price of the second advertisement.

22. The advertising method of claim 20, further comprising determining a final ranking based on the final bid price.

23. The advertising method of claim 22, wherein the determining of the final ranking comprises:
determining the final ranking in a high order of the final bid price;
determining the advertisement having the static bid price as the reserved bid price earlier than the advertisement having the maximum bid price as the reserved bid price when the final bid price is the same;
when the final bid price is the same and the type of the reserved bid prices is the same, determining the final ranking in a high order of the desired ranking; and
when the final bid price is the same, the type of the reserved bid prices is the same, and the desired ranking is the same, determining the final ranking in a high order of the registration time ranking.

24. The advertising method of claim 22, further comprising determining the contract price based on the reserved ranking or the final ranking and the final bid price,
wherein the determining of the contract price comprises determining the contract price of the m ranking advertisement as a smaller price of a price obtained by adding the final bid price of an m+1 ranking advertisement to a minimum billing reference price and the final bid price of the m ranking advertisement.

25. The advertising method of claim 24, wherein
when the number of bid submission advertisements is smaller than the number of exposure candidate advertisements to be selected, the exposure candidate advertisements and the advertisements to be exposed are the same,
the determining of the reserved ranking comprises determining the reserved ranking based on the desired ranking, the reserved bid price, and the registration time ranking of the advertisement bid when the number of bid submission advertisements is smaller than the number of exposure candidate advertisements to be selected, and
the determining of the final bid price comprises, when the number of bid submission advertisements is smaller than the number of exposure candidate advertisements to be selected, determining, as the final bid price of the lowest ranking advertisement, a smaller price than the smallest reserved bid price among the reserved bid prices of the exposure candidate advertisements when the lowest ranking advertisement is an advertisement having the maximum bid price as the reserved bid price, and determining the reserved bid price as the final bid price when the lowest ranking advertisement is an advertisement having the static bid price as the reserved bid price, and
the determining of the contract price comprises, when the number of bid submission advertisements is smaller than the number of exposure candidate advertisements to be selected, determining, as the contract price of the lowest ranking advertisement, a smaller price than the smallest reserved bid price among the reserved bid prices of the exposure candidate advertisements.
